(19) United States
(12) Patent Application Publication
(10) Pub. No.: US 2025/0296774 A1
(43) Pub. Date: Sep. 25, 2025

(54) SYSTEMS AND METHODS OF STORING OBJECTS

(71) Applicant: Corey Kinsman, Mt. Juliet, TN (US)

(72) Inventor: Corey Kinsman, Mt. Juliet, TN (US)

(21) Appl. No.: 18/615,668

(22) Filed: Mar. 25, 2024

(51) Int. Cl. B65G 1/04

(52) U.S. Cl. CPC B65G 1/0478; B65G 1/0464; B65G 2207/22

(57) ABSTRACT

A method of storing one or more goods is disclosed herein. The method may comprise providing one or more fire resistant storage containers. Each of the one or more storage containers may be constructed of an intumescent plastic material and include at least four sides defining a storage container interior. The method may further comprise receiving the one or more goods at least partially within the storage container interior of the one or more storage containers and arranging the one or more storage containers on a storage structure. Each storage container may be configured to resist the spread of fire therefrom.

### FIELD OF THE DISCLOSURE

The present disclosure relates generally to systems and methods of storing goods. More specifically, the present disclosure relates to systems and methods of storing goods in a facility using fire resistant storage containers to reduce the spread of fire.

### BACKGROUND

Traditionally, manufacturing and distribution facilities relied on human workers to organize, retrieve, and replenish inventory. However, the rise of e-commerce burdened these facilities to the point where simply relying on human workers proved untenable. For example, workers were often overworked and unable to keep up with demand, thus resulting in human errors. Moreover, these facilities required large areas to allow for ample storage with passageways and aisles for human workers to operate, for passive fire protection by way of physical separation of combustible storage, and to provide flue spaces within the storage configuration to allow for the proper operation of fire suppression systems. Thus, human workers then had to travel great distances to access inventory resulting in lost time and efficiency. In efforts to reduce costs and gain efficiency, these facilities have used various methods to implement higher-density storage parameters.

Many manufacturing and distribution facilities have begun employing automated storage and retrieval systems (ASRS). ASRS utilize robots and other automated technology to perform material handling tasks in warehouses, distribution centers, and other storage facilities. ASRS require a fraction of the space traditional, human worker-based manufacturing and storage configurations require. The storage racks are often arranged in dense grid patterns, extending both horizontally and vertically. Because these systems utilize robots to organize and retrieve inventory, less space is required within the storage configuration.

However, the high-density arrangement of ASRS increase the risk that fire may spread within the system and have a more devastating effect. As the density of inventory increases, the more easily fire may spread, and the less effective fire suppression systems (e.g. sprinkler systems) are in combating the fire because of the inability of the water to penetrate the dense storage arrangements. The basic ceiling-level sprinkler designs are typically not sufficient for ASRS, which then requires an increase in the fire suppression system design by adding in-rack sprinklers. However, in-rack sprinkler systems also lose effectiveness when storage density increases and flue spaces and/or aisles are eliminated. Moreover, firefighters may be unable to access the area in which the fire is located, and thus unable to properly fight and extinguish the fire. For example, the fire may be located deep within the storage rack arrangement where firefighters, and their hoses, are unable to effectively reach.

Another problematic factor to fires in ASRS is the rate to which they spread. ASRS often store a variety of combustible materials, which increases the fire hazard and makes design of a fire suppression system difficult. The use of automated and electrical machinery in the automated storage and retrieval system can create additional ignition sources and introduce the potential for electrical fires. Fires that start in these systems often spread quickly from storage container to storage container, finding combustible fuel in both the storage container itself and the contents of the storage container.

Current storage containers for inventory are made of plastic. To reduce the spread of fires in these systems, plastic storage containers having “fire retardant” properties have been used. Fire retardants work by disrupting the chemical reactions occurring during the combustion process. Fire retardant materials may still burn, but do so at a slower rate, thus allowing more time for emergency services to be rendered. The use of plastic storage containers having “fire retardant” properties is problematic in ASRS. While the storage containers themselves may burn at a slower rate, these storage containers do not stop the spread of the fire from the contents of one storage container to the contents of the next container. Furthermore, while the burn is slower allowing time for emergency services to arrive, these emergency services often cannot properly fight the fire due to the density of containers and limited access discussed above.

Employing ASRS often leads to elevated cost to comply with fire and building codes. For example, some fire codes and standards for ASRS require increased sprinkler design densities at the ceiling level and suggest the use of remotely operated fire monitor nozzles, perimeter access walkways for fire service access, and manual firefighting strategies specific to the unique rack configuration. With ASRS, facilities are often forced not only to place sprinklers on the ceiling of the facility, but within the storage racks. This leads to increased costs for implementation, constructability issues with installing sprinkler pipe networks through dense racking, upsizing of rack structural members to support the additional weight of wet-pipe sprinkler systems, upgrading existing warehouse facilities and water supplies, and additional training for firefighters for tactics and methods to dismantle rack systems to gain access to the potentially deep-seated fire.

Accordingly, a need exists for fire protection improvements for ASRS, and storage occupancies more generally, to reduce the effects of fires and the secondary problems of increased costs and implementation complexities of these systems and the fire protection options currently available.

### SUMMARY OF THE DISCLOSURE

This Summary of the Disclosure is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect in accordance with the optional embodiments disclosed herein is a method of storing one or more goods. The method may comprise providing one or more fire resistant storage containers. Each of the one or more storage containers may be constructed of an intumescent plastic material and include at least four sides defining a storage container interior. The method may further include receiving the one or more goods at least partially within the storage container interior of one of the one or more storage containers and arranging the one or more storage containers on a storage structure. Each storage container may be configured to resist the spread of fire therefrom.

In another aspect in accordance with the optional embodiments disclosed herein, each storage container may include a lid operable to selectively cover an open top of the storage container. The lid may be configured to resist the spread of fire from the storage container interior.

In another aspect in accordance with the optional embodiments disclosed herein, each storage container is configured to resist deformation when exposed to fire and/or heat.

In another aspect in accordance with the optional embodiments disclosed herein, the storage structure may be constructed of an intumescent plastic material.

In another aspect in accordance with the optional embodiments disclosed herein, the one or more storage containers may include at least two storage containers arranged in a vertical orientation such that a first of the two storage containers is positioned below a second of the two storage containers.

In another aspect in accordance with the optional embodiments disclosed herein, the one or more storage containers may include at least two storage containers arranged in a horizontal orientation such that a first of the two storage containers is positioned horizontally adjacent to a second of the two storage containers.

In another aspect in accordance with the optional embodiments disclosed herein, the one or more storage containers may include at least two storage containers. A first of the two storage containers may be configured to stack upon a second of the two storage containers such that the first of the two storage containers is supported by the second of the two storage containers.

In another aspect in accordance with the optional embodiments disclosed herein, a bottom side of the first of the two storage containers may substantially cover an open top of the second of the two storage containers.

Another aspect in accordance with the optional embodiments disclosed herein is a system of storing one or more goods. The system may comprise one or more fire resistant storage containers and a storage structure. Each of the one or more storage containers may be constructed of an intumescent plastic material and include at least four sides defining a storage container interior. Each storage container may be configured to receive the one or more objects at least partially within the storage container interior. Each storage container may be configured to resist the spread of fire therefrom.

In another aspect in accordance with the optional embodiments disclosed herein, a bottom side of the first of the two storage containers may substantially cover an open top of the second of the two storage containers.

In another aspect in accordance with the optional embodiments disclosed herein, each storage container may be configured to resist deformation when exposed to fire and/or heat.

In another aspect in accordance with the optional embodiments disclosed herein, the storage structure may be constructed of an intumescent plastic material.

In another aspect in accordance with the optional embodiments disclosed herein, the one or more storage containers may include at least two storage containers arranged in a vertical orientation such that a first of the two storage containers is positioned vertically adjacent to a second of the two storage containers.

In another aspect in accordance with the optional embodiments disclosed herein, the one or more storage containers may include at least two storage containers arranged in a horizontal orientation such that a first of the two storage containers is positioned horizontally adjacent to a second of the two storage containers.

In another aspect in accordance with the optional embodiments disclosed herein, the one or more storage containers may include at least two storage containers. A first of the two storage containers may be configured to stack upon a second of the two storage containers such that the first of the two storage containers is supported by the second of the two storage containers.

In another aspect in accordance with the optional embodiments disclosed herein, a bottom side of the first of the two storage containers may substantially cover an open top of the second of the two storage containers.

Numerous objects, features and advantages of the present invention will be readily apparent to those skilled in the art upon a review of the following description in conjunction with the accompanying drawings.

### BRIEF DESCRIPTION OF THE DRAWINGS

FIG. 1 is a perspective view of a system of storing one or more objects in a warehouse facility of the present disclosure.

FIG. 2 is a perspective view of a fire resistant storage container of the system of FIG. 1 in accordance with the present disclosure wherein the fire resistant storage container consists of five sides.

FIG. 3 is a perspective view of a fire resistant storage container of the system of FIG. 1 in accordance with the present disclosure wherein the fire resistant storage container includes a lid.

FIG. 4 is a block diagram representing a method of storing one or more objects in accordance with the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected,” “attached,” “joined,” “mounted,” “fastened,” and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

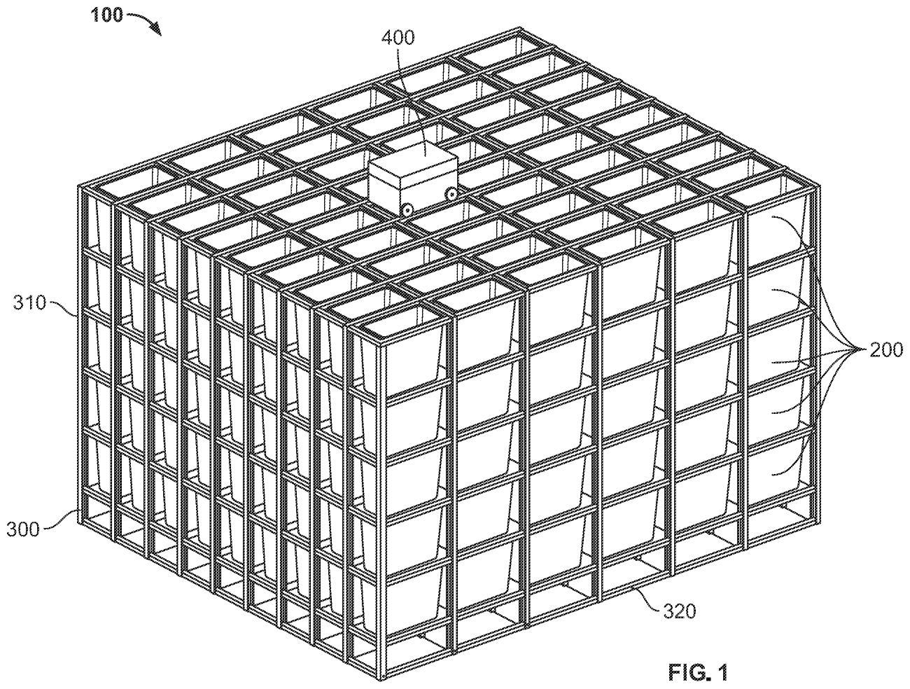

Referring now to the figures, and specifically FIG. 1, a system of storing one or more objects in a warehouse facility is shown and generally designated by the number 100. The system 100 may be configured to employ traditional storage configurations intended for human workers or automatic storage and retrieval techniques. The system 100 may include one or more fire resistant storage containers 200, one or more storage structures 300, and one or more automated tools 400. The one or more fire resistant storage containers 200 may be arranged on or around the one or more storage structures 300.

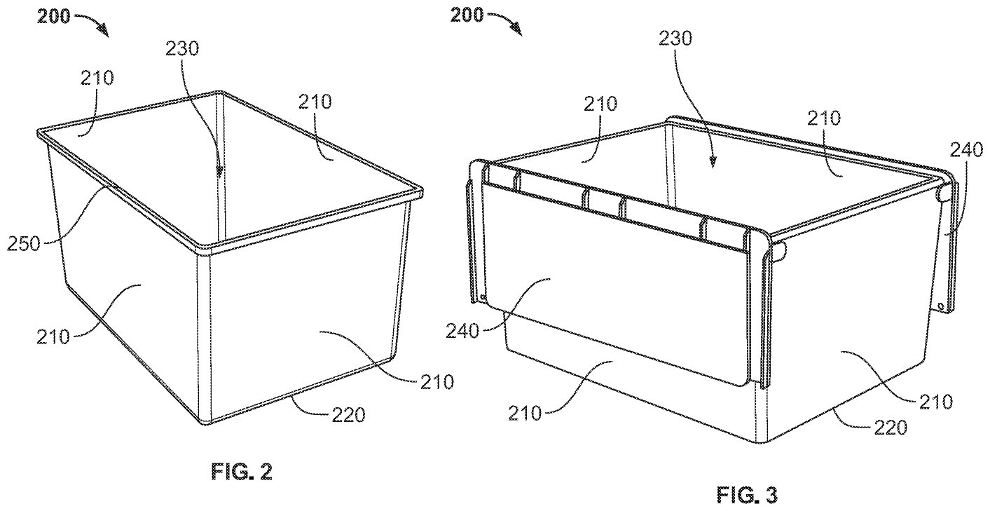

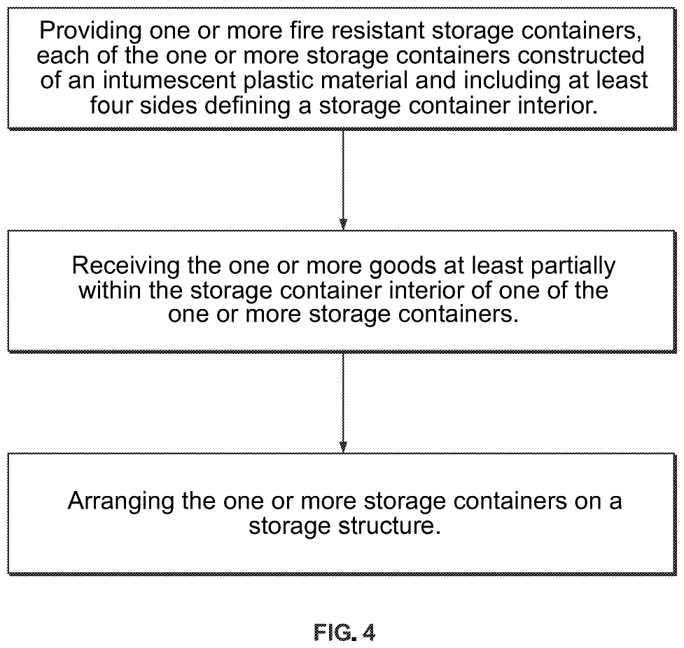

Each of the one or more fire resistant storage containers 200 may be formed from a combination of materials and components and can provide a variety of functions. In one optional embodiment, each fire resistant storage container 200 may include five (5) sides, including four (4) vertical sides 210 and a bottom side 220. Each of the vertical sides 210 may extend up from the bottom side 220 thus defining a storage container interior 230. The storage container interior 230 may be operable to receive one or more objects at least partially therein. The optional embodiment of the fire resistant storage container 200 having five (5) sides may be referred to herein as an open-top embodiment or an open-top fire resistant storage container 200. An exemplary embodiment of the open-top fire resistant storage container 200 is shown in FIG. 2.

In certain optional embodiments, the fire resistant storage container 200 may include four (4) sides, including three (3) vertical sides 210 and a bottom side 220. Each of the vertical sides 210 may extend up from the bottom side 220 thus defining a storage container interior 230. The storage container interior 230 may be operable to receive one or more objects at least partially therein. The fire resistant storage container 200 may have an open end where there is no vertical side 210.

In certain optional embodiments, the fire resistant storage container 200 may include a lid 240. The lid 240 may be operable to selectively cover an open top of the fire resistant storage container 200. In certain optional embodiments, the lid 240 may be pivotally connected to one or more of the vertical sides 210 of the fire resistant storage container 200. Thus, the lid 240 may be pivoted relative to the vertical sides 210 between a closed position wherein it covers the open top of the fire resistant storage container 200 and an open position wherein it leaves the open top of the fire resistant storage container 200 uncovered. An exemplary embodiment of the fire resistant storage container 200 having a lid 240 is shown in FIG. 3. In other optional embodiments, the lid 240 may be configured to selectively couple to one or more of the vertical sides 210.

The fire resistant storage container 200 may include an upper lip 250 located along the upper end of the four vertical sides 210. In certain optional embodiments, the upper lip 250 may be operable as a handle for a human worker to grasp when picking up the fire resistant storage container 200. The upper lip 250 may also be configured to rest upon a portion of the storage structure 300. In embodiments of the fire resistant storage container 200 having a lid 240 configured to selectively couple to one or more the vertical sides 210, the upper lip 250 may be configured to selectively couple the lid 240 to the vertical sides 210. The upper lip 250 and the lid 240 may form an interference fit wherein the lid 240 may be secured in place relative to the vertical sides 210.

In certain optional embodiments, the fire resistant storage container 200 may be stackable. The upper lip 250 may be configured such that the bottom side 220 of another fire resistant storage container 200 may rest thereupon. In this way, a first fire resistant storage container 200A may be stacked upon a second fire resistant storage container 200B such that the second fire resistant storage container 200B supports the first fire resistant storage container 200A. The bottom side 220 of the first fire resistant storage container 200A, when positioned on top of the second fire resistant storage container 200B, may substantially cover the open top of the second fire resistant storage container 200B. In this configuration, the bottom side 220 of the first fire resistant storage container 200A may act as a lid or covering to the second fire resistant storage container 200B.

In certain optional embodiments, the fire resistant storage containers 200 may be nestable. In certain use cases, it may be desirable to nest one of the fire resistant storage container 200 within another fire resistant storage container 200. Thus, in certain optional embodiments, the fire resistant storage container 200 may be configured such that each fire resistant storage container 200 may be nested within another fire resistant storage container 200. More specifically, the bottom side 220 and portions of the vertical sides 210 of a first fire resistant storage container 200A may be received within the storage container interior 230 of a second fire resistant storage container 200B. Thus, less space may be required to store several of the fire resistant storage containers 200 when they are nested.

One of skill in the art will appreciate that it is within the spirit and scope of the present disclosure for the fire resistant storage container 200 to be configured in a variety of shapes and sizes. For example, the vertical sides 210 may be oriented substantially vertical or may be angled. The vertical sides 210 and the bottom side 220 may be a variety of sizes, and thus a volume of the storage container interior 230 may vary. Furthermore, the vertical sides 210 may each be similar, or each vertical side 210 may include distinct features.

The one or more storage structures 300 may be operable to support the one or more fire resistant storage containers 200. The one or more storage structures 300 may include storage racks, storage shelves, or the like. In certain optional embodiments, each of the one or more storage structures 300 may include a plurality of vertical supports 310 and a plurality of horizontal supports 320. A first set of parallel horizontal supports 320A are arranged perpendicularly to a second set of parallel horizontal supports 320B to form a horizontal grid structure supported by the vertical supports 310. Each of the fire resistant storage containers 200 may be positioned between the vertical supports 310 and horizontal supports 320 of the storage structure 300. While this is one possible configuration of the storage structure 300, the storage structures 300 may support the one or more fire resistant storage containers 200 in a variety of configurations.

In certain optional embodiments, the storage structures 300 may support a plurality of fire resistant storage containers 200 arranged in a vertical orientation. In the vertical orientation, a first fire resistant storage container 200A may be positioned below a second fire resistant storage container 200B. In certain optional embodiments, for example where the storage structures 300 are arranged in a grid pattern, there may be more than two fire resistant storage containers 200 arranged in a vertical orientation. In certain optional embodiments, each fire resistant storage container 200 may be supported by a portion of the storage structure 300. In other optional embodiments, each fire resistant storage container 200 may simply be stacked upon another fire resistant storage container 200. In certain optional embodiments, the storage structures 300 may support a plurality of fire resistant storage containers 200 arranged in a horizontal orientation. In the horizontal orientation, a first fire resistant storage container 200A may be positioned horizontally adjacent to a second fire resistant storage container 200B. In certain optional embodiments, for example where the storage structures 300 are arranged in a grid pattern, there may be more than two fire resistant storage containers 200 arranged in a horizontal orientation.

The fire resistant storage containers 200 may be generally arranged in a grid pattern when supported by the one or more storage structures 300. In certain optional embodiments, the fire resistant storage containers 200 may each be accessible via a rotatable conveyor system. In other optional embodiments, the fire resistant storage containers 200 may each be accessible by selectively translating from the storage structure 300. One of skill in the art will appreciate that it is within the spirit and scope of the present disclosure for each of the fire resistant storage containers 200 to be accessible and arranged in other ways known in the art and not limited to the exemplary configurations discussed above.

The automated tools 400 may be operable to perform a variety of tasks associated with the fire resistant storage containers 200 and storage structures 300 of the system 100. In certain optional embodiments, the automated tools 400 may include a robot operable to retrieve fire resistant storage containers 200 or the contents thereof in response to a human and/or machine generated request. The automated tools 400 may be operable to sort, arrange, and/or selectively maneuver the fire resistant storage containers 200 and/or the storage structures 300 in any desirable configuration. The automated tools 400 may be operable to move along portions of the storage structures 300 and/or may be operable to move along a ground surface. In other optional embodiments, the automated tools 400 may be mounted to an object and/or support structure, as in the exemplary case where the automated tools 400 includes a robotic arm.

The one or more fire resistant storage containers 200 may be constructed of an intumescent plastic material. In certain optional embodiments, the intumescent plastic material may swell when exposed to fire and/or extreme heat. However, the intumescent plastic material may maintain its structural properties, thus maintaining its position relative to the storage structures 300 and the contents therein.

In certain optional embodiments, the intumescent plastic material may include a mixture of thermoplastic material and intumescent powder. The thermoplastic material may be heated to a plastic state for mixing with the intumescent powder. The thermoplastic material may include polyvinyl chloride (PVC), polyethylene, polypropylene ethyl vinyl acetate (EVA), acrylonitrile butadiene styrene (ABS) copolymers, polyethylene acrylates, and thermoplastic polyester. The intumescent powder may comprise alkali silicate powder, and may further contain lithium oxide. The alkali silicate may have a high degree of intumescence and a temperature of intumescence above a plastic temperature of the thermoplastic materials. The alkali silicate powder may be a mixed Li/Na/K silicate. In certain optional embodiments, the intumescent powder may include a compound with a formulation of: 3.62 SiO₂/0.26 Li₂O: 0.74: (Na₂O+K₂O) or 2.48 SiO₂/0.26 Li₂O: 0.74: (Na₂O+K₂O). The intumescent powder may have an intumescent point in a range of between 185° C. to 230° C., preferably 190° C. to 225° C., and most preferably 195° C. to 220° C.

While exemplary formulations of the intumescent plastic material are disclosed herein, one of skill in the art will appreciate that it is within the spirit and scope of the present disclosure to use other formulations. Moreover, in certain optional embodiments, other components of the system 100 may be constructed of the intumescent plastic material, such as the one or more storage structures 300 or the automated tools 400 to name a few examples.

The one or more fire resistant storage containers 200 may be configured to resist the spread of fire therefrom. Where a fire originates within an open-top embodiment of the fire resistant storage container 200, the fire may escape through the open top. However, the system 100 may still reduce the spread of the fire through its use of intumescent plastic materials throughout the system 100. For example, fire resistant storage containers 200 adjacent to the fire resistant storage container 200 containing the fire may resist the fire and/or heat created by the fire. Moreover, the adjacent fire resistant storage containers 200 may prevent their contents from being exposed to the fire. The storage structures 300 or automated tools 400 associated with the system 100 may also be constructed of intumescent plastic material, and thus resist the fire. Because the various components of the system 100 are fire resistant and the contents of the fire resistant storage containers 200 are shielded, the fire may not have any further fuel sources and may cease to burn and/or spreading may be reduced. The fire may be extinguished because there is no viable fuel (e.g., all surrounding material has intumescent properties), existing sprinkler systems reach the fire, and/or firefighters reach the fire. Therefore, the fire may be substantially contained within a single fire resistant storage container 200.

In optional embodiments of the fire resistant storage containers 200 having the lid 240, the lid 240 may be placed in the closed position to further reduce the spread of fire from within the fire resistant storage containers 200. The lid 240 may be placed in the closed position as part of standard practice to reduce the potential effects of a future fire. Alternatively, the lid 240 may be moved into the closed position, by the automated tools 400 for example, in response to a detected fire.

In certain optional embodiments, the fire resistant storage container 200 may be configured to resist deformation when exposed to fire and/or heat. Thus, the fire resistant storage containers 200 may maintain substantially the same shape and size when exposed to fire and/or heat. One advantage of this aspect of the disclosure may be that the fire resistant storage container 200 maintains its contents therein when exposed to fire and/or heat. In certain optional embodiments, the intumescent material may swell when exposed to fire and/or heat, but the structural integrity of the fire resistant storage container 200 may not be affected.

Another aspect in accordance with the present disclosure is a method of storing one or more objects in a facility. The facility may be, to name a few examples, a distribution center, a storage center, a drop-shipping center, a manufacturing facility, a repair garage, a self-storage facility, a retail facility, or the like.

The method may include providing one or more fire resistant storage containers 200. As previously mentioned, each of the one or more fire resistant storage containers 200 may be constructed of the intumescent plastic material. In certain optional embodiments, each fire resistant storage container 200 may include five (5) sides, including four (4) vertical sides 210 and bottom side 220. In other optional embodiments, each fire resistant storage container 200 may include four (4) vertical sides 210 and a bottom side 220. Each of the vertical sides 210 may extend up from the bottom side 220 thus defining a storage container interior 230.

The method may further include receiving the one or more objects at least partially within the storage container interior 230 of the one or more fire resistant storage containers 200.

The method may further include arranging the one or more fire resistant storage containers 200 on the one or more storage structures 300. The one or more storage structures 300 may be arranged in any contemplated orientation and/or arrangement.

One benefit of the system 100 may be a reduced need for fire suppression systems. National Fire Protection Association (NFPA) 13 provides the standard for the installation of sprinkler systems. NFPA 13 may be referenced by building and fire codes for the appropriate design and installation of fire sprinkler systems. When designing a sprinkler system, one may determine the hazard level wherein the hazard level may include the commodity classification. This classification may be a grouping of similar items that can be protected by a particular design. “Commodity,” as defined by NFPA 13, is the combination of products, packing material, and container that determines commodity classification. In traditional automated storage and retrieval systems, many fire codes require increased sprinkler design densities at the ceiling level and suggest remotely-operated fire monitor nozzles, perimeter access walkways for fire service access, and manual firefighting strategies specific to the unique storage rack configuration. Using the fire resistant storage container 200 may change the commodity classification and reduce the hazard level. Therefore, by employing the system 100 disclosed herein, the fire code requirements for a given facility may be substantially less due to the use of the fire resistant storage container 200.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A method of storing one or more goods, the method comprising:
providing one or more fire resistant storage containers, each of the one or more storage containers constructed of an intumescent plastic material and including at least four sides defining a storage container interior;
receiving the one or more goods at least partially within the storage container interior of one of the one or more storage containers;
arranging the one or more storage containers in a storage configuration, wherein the storage configuration includes arranging the one or more storage container on a storage structure; and
wherein each of the one or more storage containers is configured to resist the spread of fire therefrom.

2. The method of claim 1, wherein:
each storage container includes a lid operable to selectively cover an open top of the storage container, the lid configured to resist the spread of fire from the storage container interior.

3. The method of claim 1, wherein:
each storage container is configured to resist deformation when exposed to fire and/or heat.

4. The method of claim 1, wherein:
the storage structure is constructed of an intumescent plastic material.

5. The method of claim 1, wherein:
the one or more storage containers includes at least two storage containers arranged in a vertical orientation such that a first of the two storage containers is positioned below a second of the two storage containers.

6. The method of claim 1, wherein:
the one or more storage containers includes at least two storage containers arranged in a horizontal orientation such that a first of the two storage containers is positioned horizontally adjacent to a second of the two storage containers.

7. The method of claim 1, wherein:
the one or more storage containers includes at least two storage containers, a first of the two storage containers configured to stack upon a second of the two storage containers such that the first of the two storage containers is supported by the second of the two storage containers.

8. The method of claim 7, wherein:
a bottom side of the first of the two storage containers substantially covers an open top of the second of the two storage containers.

9. A system of storing one or more goods, the system comprising:
one or more fire resistant storage containers, each of the one or more storage containers constructed of an intumescent plastic material and including at least four sides defining a storage container interior, each storage container configured to receive the one or more goods at least partially within the storage container interior;
a storage structure configured to support the one or more storage containers; and
wherein each storage container is configured to resist the spread of fire therefrom.

10. The system of claim 9, wherein:
each storage container includes a lid operable to selectively cover an open top of the storage container, the lid configured to resist the spread of fire from the storage container interior.

11. The system of claim 9, wherein:
each storage container is configured to resist deformation when exposed to fire and/or heat.

12. The system of claim 9, wherein:
the storage structure is constructed of an intumescent plastic material.

13. The system of claim 9, wherein:
the one or more storage containers includes at least two storage containers arranged in a vertical orientation such that a first of the two storage containers is positioned vertically adjacent to a second of the two storage containers.

14. The system of claim 9, wherein:
the one or more storage containers includes at least two storage containers arranged in a horizontal orientation such that a first of the two storage containers is positioned horizontally adjacent to a second of the two storage containers.

15. The system of claim 9, wherein:
the one or more storage containers includes at least two storage containers, a first of the two storage containers configured to stack upon a second of the two storage containers such that the first of the two storage containers is supported by the second of the two storage containers.

16. The system of claim 15, wherein:
a bottom side of the first of the two storage containers substantially covers an open top of the second of the two storage containers.
